(19) United States
(12) Patent Application Publication
(10) Pub. No.: US 2005/0134222 A1
(43) Pub. Date: Jun. 23, 2005

(54) Charging control for battery powered devices

(76) Inventor: Michael D. Stinson, San Diego, CA (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 11/001,918

(22) Filed: Dec. 2, 2004

Related U.S. Application Data
(60) Provisional application No. 60/530,543, filed on Dec. 18, 2003.

(51) Int. Cl. H02J 7/00

(52) U.S. Cl. 320/128

(57) ABSTRACT

A method and apparatus for controlling the charge cycle of a rechargeable power source within portable electronic equipment is disclosed. When external power is applied to the portable electronic equipment, a determination is made of the present power capacity of the rechargeable power source for the equipment. If the present capacity is lower than a predetermined value, then a charge cycle is initiated. If the present capacity is not lower than the predetermined value, then a charge cycle is not initiated. Furthermore, the predetermined value may be fixed or adjustable by a user.

This application is related to, and claims priority to U.S. provisional application No. 60/530,543, filed Dec. 18, 2003, entitled “Charging Control Circuit For Notebooks”, Attorney Docket Number P1930US00, the entirety of which is incorporated by reference herein, including all of the documents referenced therein.

### FIELD OF THE INVENTION

The present invention generally relates to the field of charging power sources in portable equipment.

### BACKGROUND OF THE INVENTION

Portable electronic devices often have rechargeable power sources such as batteries. Many portable devices provide circuitry for recharging these power sources when auxiliary sources of power are available, perhaps AC line voltage. Presently, when an auxiliary power source is connected to an electronic device having a rechargeable power source and associated charging circuit, the charging circuit initiates a charge cycle. Unfortunately, most rechargeable batteries degrade with each recharge cycle and are generally rated by the number of recharge cycles that can be performed before the battery can hold only around one half its original power capacity. Generally, it does not make a significant difference in degradation whether a battery is recharged from a fully discharged state or from an almost fully charged state.

Many usage scenarios for portable electronic devices include disconnecting the electronic device from an auxiliary power source, then using the electronic device for a limited a mount of time while disconnected, then re-connecting the electronic device to the auxiliary power source. For example, one may take a notebook computer from their office to a meeting and only actively use it for a few minutes. When returning to their office, they may reconnect the notebook computer to an auxiliary power source and it may initiate a recharge of its rechargeable batteries, even though they are almost fully charged. This causes unnecessary degradation of the rechargeable batteries.

Therefore, it would be desirable to provide a system and method for reducing the number of unnecessary recharge cycles or frequency of unnecessary recharge cycles for a rechargeable battery.

### SUMMARY OF THE INVENTION

Accordingly, the present invention is directed to a system and method for controlling the charge cycle of a rechargeable power source within portable electronic equipment to reduce the number of unnecessary recharge cycles for prolonging the useful life of the rechargeable power source.

In one aspect of the present invention, when auxiliary power is applied to the portable electronic equipment, the present charge level of its rechargeable batteries is determined. If the present charge level is relatively high, no charge cycle is initiated and the portable electronic equipment is powered by the auxiliary power source.

In another aspect of the present invention, when auxiliary power is applied to the portable electronic equipment, the present charge level of its rechargeable batteries is determined. If the present charge level is relatively high, no charge cycle is initiated, the portable electronic equipment is powered by the auxiliary power source and a trickle charge is provided to the rechargeable batteries to maintain their present charge level.

In another aspect of the present invention, when auxiliary power is applied to the portable electronic equipment, the present charge level of its rechargeable batteries is determined. If the present charge level is higher than a predetermined threshold, no charge cycle is initiated and the portable electronic equipment is powered by the auxiliary power source. The threshold may be provided as an absolute value or percentage of total capacity. Furthermore, in another embodiment, the threshold may be adjusted by the user.

In another aspect of the present invention, when auxiliary power is applied to the portable electronic equipment, the present charge level of its rechargeable batteries is determined. If the present charge level is higher than a predetermined threshold, no charge cycle is initiated, the portable electronic equipment is powered by the auxiliary power source and a trickle charge is provided to the rechargeable batteries to maintain their present charge level. The threshold may be provided as an absolute value or percentage of total capacity. Furthermore, in another embodiment, the threshold may be adjusted by the user.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram of an illustrative system implementing the present invention.

FIG. 2 is a flow chart of the present invention.

FIG. 3 is a flow chart of the present invention.

### DETAILED DESCRIPTION OF THE INVENTION

Reference will now be made in detail to the presently preferred embodiments of the invention, examples of which are illustrated in the accompanying drawings.

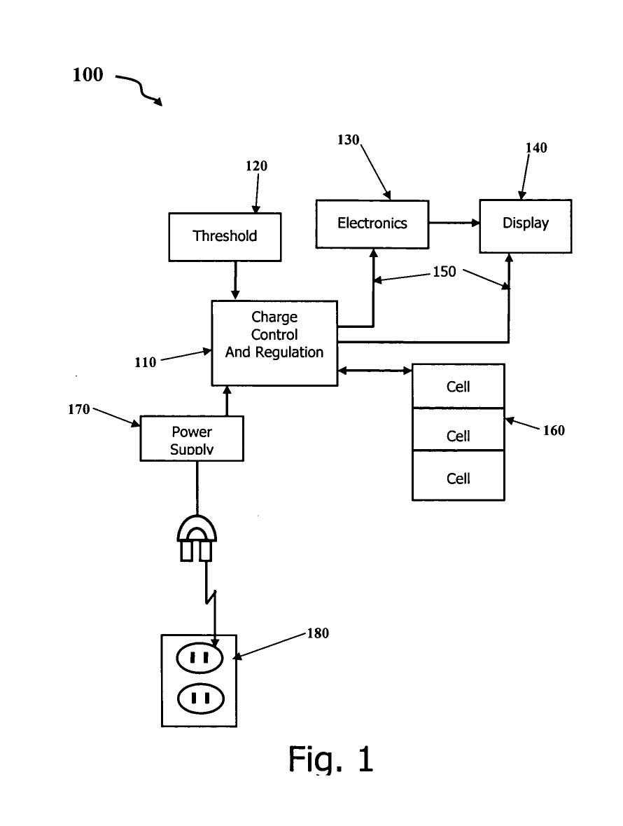

Referring generally now to FIG. 1, an illustrative electronic system according to the present invention is shown. The system shown is an example of an electronic device 100 having a rechargeable power source 160, electronics that may be powered by the rechargeable power source 130, a display 140 which may be an LCD, a charge control circuit 110, and a power supply 170. The power supply 170 may be internal to the electronic device or, perhaps, may be external such as provided with many portable electronic devices such as printers, notebook computers and the like. The power supply may or may not be connected to an external power source 180, such as an AC outlet configured to provide AC line voltage.

Charge control circuit 110 monitors the status of the rechargeable power source 160, or in this case a three-cell battery pack. When the electronic device is in use, charge control and regulation 110 provides regulated power to the electronics 130 and display 140 through connections 150. In this embodiment, power supply 170 is shown disconnected from AC outlet 180. In this mode, power for the system is provided by rechargeable power source 160 through charge control circuit 110. When power supply 170 is connected to AC outlet 180, it provides power to charge control circuit 110. Recognizing this incoming power, charge control circuit 110 determines if rechargeable power source 160 should be recharged by determining the present charge of rechargeable power source 160 and comparing the present charge to threshold 120. If the present charge is greater than threshold 120, charge control circuit 110 does not initiate a charge cycle and may provide a trickle charge to rechargeable power source 160 to maintain its current charge level. If the present charge is less than threshold 120, charge control circuit 110 initiates a charge cycle of rechargeable power source 160. Once rechargeable power source 160 is fully charged, charge control circuit 110 may revert to a trickle charge to maintain a full charge of rechargeable power source 160. Preferably, the value of the threshold 120 may be between approximately 75 percent and approximately 25 percent of the full charge capacity of the rechargeable power source 160. In one embodiment of the invention, the value of the threshold 120 may be approximately 50 percent of the full charge capacity of the rechargeable power source 160.

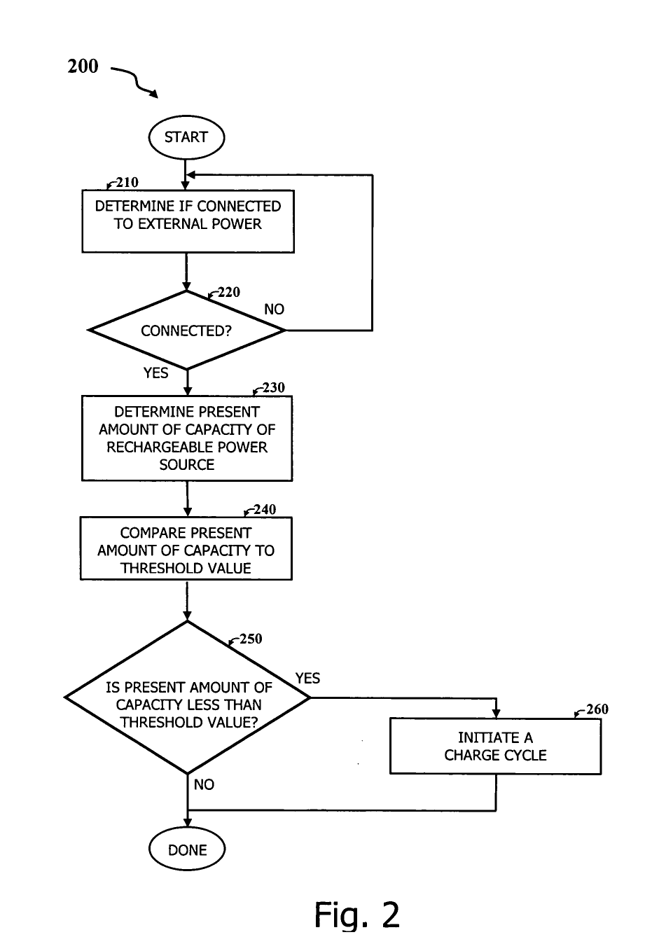

Referring now to FIG. 2, a flow chart of the present invention is shown. The status of external power is checked (step 210). If not connected to external power (determined at step 220), then step 210 is repeated. If connected to external power, the present charge capacity of the rechargeable power source is determined (step 230). This may be done by various methods known in the industry, including an actual measurement of the battery (perhaps by measuring its impedance) or by monitoring how much charge is put into the battery and how much power has been consumed by the electronic device. The present charge capacity is compared to a threshold value (step 240). This threshold value may be a preset amount or may be administered by the user. If the present charge capacity is less than the threshold (step 250), then a charge cycle is initiated (step 260). Otherwise, no charge cycle is initiated and the flow is complete.

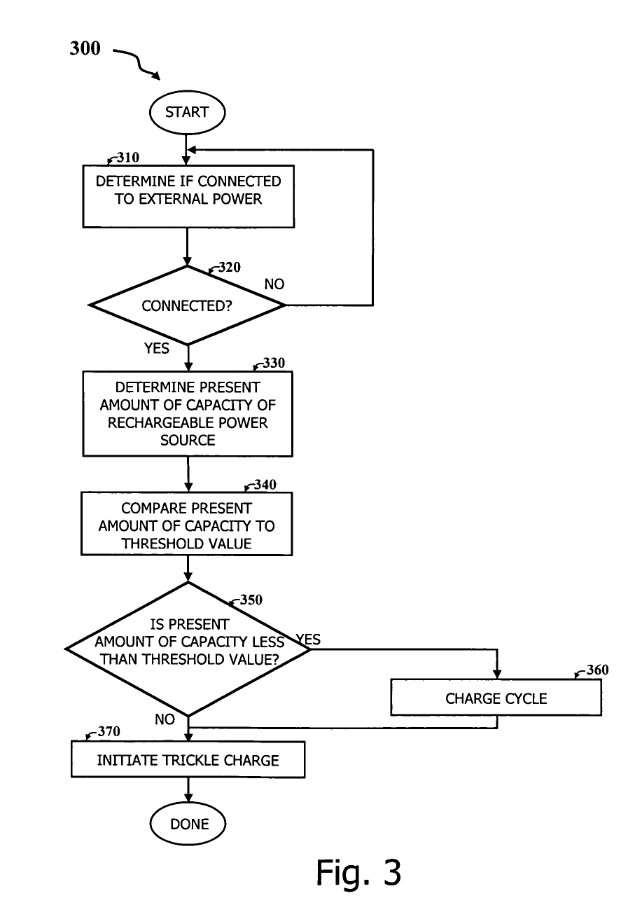

Referring now to FIG. 3, a flow chart of the present invention is shown. The status of external power is checked (step 310), and if not connected to external power (step 320), then step 310 is repeated. If connected to external power, the present charge capacity of the rechargeable power source is determined (step 330). This may be done by various methods known in the industry, including an actual measurement of the battery (perhaps by measuring its impedance) or by monitoring how much charge is put into the battery and how much power has been consumed by the electronic device. The present charge capacity is compared to a threshold value (step 340). This threshold value may be a preset amount or may be administered by the user. If the present charge capacity is less than the threshold (step 350), then a charge cycle is executed (step 360). If the present charge capacity is higher than the threshold or the charge cycle is completed, a trickle charge of the rechargeable power source is initiated to maintain its present charge (step 370).

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. An apparatus for controlling the charging of a rechargeable power source within an electronic device comprising:
a rechargeable power source;
a charge control circuit configured to charge said rechargeable power source;
logic to determine a present charge of said rechargeable power source; and
an auxiliary power source connectably attached to said charge control circuit;
wherein said charge control circuit is configured to initiate a charge cycle of said rechargeable power source after said auxiliary power source is connected to said charge control circuit and said present charge is below a predetermined value.

2. The apparatus for controlling the charging of a rechargeable power source within an electronic device of claim 1, wherein said predetermined value is between approximately 25 percent and approximately 75 percent of a total capacity of said rechargeable power source.

3. The apparatus for controlling the charging of a rechargeable power source within an electronic device of claim 1, wherein said predetermined value is threshold settable by a user.

4. The apparatus for controlling the charging of a rechargeable power source within an electronic device of claim 1, wherein said rechargeable power source is a battery pack.

5. The apparatus for controlling the charging of a rechargeable power source within an electronic device of claim 4, wherein said battery pack comprises battery cells selected from a group consisting of lithium ion cells, nickel metal hydride cells, nickel cadmium cells, lead-acid cells and lithium polymer cells.

6. The apparatus for controlling the charging of a rechargeable power source within an electronic device of claim 1, further comprising:
a trickle charge circuit configured to provide a trickle charge to said rechargeable power source when said auxiliary power source is connected to said charge control circuit and said charge control circuit is not within said charge cycle.

7. The apparatus for controlling the charging of a rechargeable power source within an electronic device of claim 1, wherein said charge control circuit also provides power to circuitry within said electronic device.

8. The apparatus for controlling the charging of a rechargeable power source within an electronic device of claim 7, wherein said electronic device is a portable computer.

9. A method for controlling the charging of a rechargeable power source within an electronic device comprising:
detecting connection to an alternate power source;
upon said detecting:
determining a present charge capacity of a rechargeable power source;
comparing said present charge capacity to a predetermined value; and
if said present charge capacity is less than said predetermined value, initiating a charge cycle.

10. The method for controlling the charging of a rechargeable power source within an electronic device of claim 9, wherein said predetermined value is between approximately 25 percent and approximately 75 percent of a total capacity of said rechargeable power source.

11. The method for controlling the charging of a rechargeable power source within an electronic device of claim 9, wherein said predetermined value is threshold settable by a user.

12. The method for controlling the charging of a rechargeable power source within an electronic device of claim 9, wherein said rechargeable power source is a battery pack.

13. The method for controlling the charging of a rechargeable power source within an electronic device of claim 12, wherein said battery pack comprises battery cells selected from a group consisting of lithium ion cells, nickel metal hydride cells, nickel cadmium cells, lead-acid cells and lithium polymer cells

14. The method for controlling the charging of a rechargeable power source within an electronic device of claim 9, further comprising the step of:
providing a trickle charge to said rechargeable power source when said auxiliary power source is connected and when not in said charge cycle.

15. The method for controlling the charging of a rechargeable power source within an electronic device of claim 9, wherein auxiliary power source is DC voltage provided from a power supply that in turn receives power from an AC line voltage.

16. A notebook computer comprising:
a battery pack;
a charge control circuit configured to charge said battery pack;
logic to determine a present charge of said battery pack; and
an auxiliary power source connectably attached to said charge control circuit;
wherein said charge control circuit is configured to initiate a charge cycle of said battery pack after said auxiliary power source is connected to said charge control circuit and said present charge is below a predetermined value.

17. The notebook computer of claim 16, wherein said predetermined value is between approximately 25 percent and approximately 75 percent of a total capacity of said rechargeable power source.

18. The notebook computer of claim 16, wherein said predetermined value is threshold settable by a user.

19. The notebook computer of claim 16, wherein said battery pack comprises battery cells selected from a group consisting of lithium ion cells, nickel metal hydride cells, nickel cadmium cells, lead-acid cells and lithium polymer cells.

20. The notebook computer of claim 16, further comprising:
a trickle charge circuit configured to provide a trickle charge to said battery pack when said auxiliary power source is connected to said charge control circuit and said charge control circuit is not within said charge cycle.

21. The notebook computer of claim 16, wherein said charge control circuit also provides power to circuitry within said notebook computer.
